(19) United States
(12) Patent Application Publication
(10) Pub. No.: US 2010/0244732 A1
(43) Pub. Date: Sep. 30, 2010

(54) DISPLAY DEVICE, IN PARTICULAR TRANSPARENT MULTIMEDIA FACADE

(76) Inventors: Peter Kracht, Holzminden (DE); Bernd Albrecht, Delligsen (DE); Daniel Grimm, Stadecken-Elsheim (DE); Angelika Ullmann, Coppenbrugge (DE); Marten Walther, Alfeld (DE); Ernst-Friedrich Duesing, Alfeld/L (DE); Horst Schillert, Grunenplan (DE); Matthias Anton, Einbeck (DE); Andreas Nickut, Delligsen (DE); Christoph Lothar Doeppner, Eichenzell-Luetter (DE); Wolfgang Moehl, Worms (DE); Rolf A. O. Schneider, Rottenburg am Neckar (DE); Christian Henn, Frei-Laubersheim (DE)

Correspondence Address: TAYLOR IP, P.C., P.O. Box 560, 142. S Main Street, Avilla, IN, 46710, US

(21) Appl. No.: 12/648,779

(22) Filed: Dec. 29, 2009

Related U.S. Application Data
(63) Continuation of application No. PCT/EP2008/005273, filed on Jun. 30, 2008.
(60) Provisional application No. 60/947,794, filed on Jul. 3, 2007.

(30) Foreign Application Priority Data
Jul. 3, 2007 (DE) 10 2007 030 923.8
Jul. 6, 2007 (DE) 10 2007 031 641.2
Jul. 6, 2007 (DE) 10 2007 031 642.0
Feb. 19, 2008 (DE) 10 2008 009 775.6

(51) Int. Cl. H05B 37/02; F21S 4/00; F21V 9/00

(52) U.S. Cl. 315/294; 362/249.01; 362/249.02; 362/231; 362/249.16

(57) ABSTRACT

A large-area display device, in particular multimedia façade, comprises at least one transparent element, in which the transparent element comprises at least one transparent substrate on which one or more lighting elements is/are arranged.

### CROSS REFERENCE TO RELATED APPLICATIONS

This is a continuation of PCT application No. PCT/EP2008/005273, entitled “DISPLAY DEVICE, IN PARTICULAR TRANSPARENT MULTIMEDIA FACADE”, filed Jun. 30, 2008, which is incorporated herein by reference. PCT application No. PCT/EP2008/005273 is a non-provisional application based upon U.S. provisional patent application Ser. No. 60/947,794, entitled “TRANSPARENT MULTIMEDIA FRONT”, filed Jul. 3, 2007, which is incorporated herein by reference.

### BACKGROUND OF THE INVENTION

1. Field of the Invention

The invention pertains to a display device, in particular to a large-area display device, and more specifically to a transparent multimedia façade.

2. Description of the Related Art

From the state of technology large-area display devices are known, for example large-area video displays of open air sporting events or in the form of media façades that consist out of lamellae. The individual lamellae are equipped with lighting devices, for example with light-emitting diodes (LED). The lamellae themselves are assembled into gratings or grids. The structures of these grids are very prominent because of the thickness of the individual lamellae, which are up to 20 mm or even more. The grid structures or the lamellae, respectively, can also be mounted in front of the façades of a building. Inside of these lamellae are lighting devices integrated, preferably LED's. With the help of media façades it is possible to illuminate large areas of the façades with many colors. It is then possible to create sequences of colors or animated graphics on these large-area video displays or media façades, respectively. It is also possible to show video pictures or moving television pictures stretched over large areas with the help of these display devices on these façades. A distinct disadvantage, based on the existing state of technology, was that these display devices were not transparent to any significant level, or that it would require intricate and expensive constructions and that a plurality of lamellae would need to be mounted open in front of the façade of the building. The individual light-emitting diodes would then be arranged on these lamellae. The lamellae themselves were very sensitive to weather conditions, in particular extreme weather conditions such as wind, and they could only be made with great expense.

What is needed in the art is a large-area display device, in particular a media façade, which overcomes the disadvantages of the current state of technology, in particular its expensive construction.

### SUMMARY OF THE INVENTION

The present invention provides a large-area display device, in particular a media façade, which includes an element that consists at least partially out of a transparent and/or a quasi-transparent element, whereby the transparent and/or a quasi-transparent element includes at least one transparent and/or a quasi-transparent substrate, and where lighting devices are mounted on at least parts of these transparent and/or a quasi-transparent substrates.

The mounting of the lighting device on the transparent substrate is facilitated, example as described in EP-A 1 450 416. The transparent and/or quasi-transparent substrate is transparent or quasi-transparent in the regime of visible light and it can be structured in any desirable way. The lighting devices are according to this invention directly attached to one surface of the transparent substrate.

Transparent substrates are in particular substrates, such as for example glasses, with a transmission of ≧80%, but preferably with a transmission of ≧90% in the visible spectrum of light under a perpendicular angle of incidence of the light. The visible spectrum of light spans the range of wavelengths from 380 nm up to 780 nm, but preferably from 420 nm up to 780 nm.

Quasi-transparent substrates are those with transmissions of 40% up to 80% in the visible spectrum of light under a perpendicular angle of incidence of the light.

Material choices for transparent and/or quasi-transparent substrates includes all of the inorganic glasses, in particular silicate glasses, preferably soda-lime glasses, but also borosilicate glasses, and in particular fire protective glasses. Other material choices for transparent and/or quasi-transparent substrates can also include plastics that are transparent in the spectrum of visible light, in particular glass clear or transparent plastics, such as for example polymethyl methacrylates, acrylic glass or even polycarbonates.

By way of the construction of a large-area display device according to this invention, which includes at least in part a transparent and/or quasi-transparent element, which in turn includes at least one transparent and/or quasi-transparent substrate, it is possible, for example to create a transparent and/or quasi-transparent media façade that would permit seeing through the media façade, which is mounted to the building and would permit viewing the building from the outside or seeing through the media façade mounted to the building and view of the outside from the inside of the building, and which at the same time does not require an expensive lamellar construction.

The media façade can be built such that it is made out of transparent and/or quasi-transparent façade elements, or otherwise that in particular a transparent and/or quasi-transparent media façade is hung, for example, onto an already existing façade. The lighting devices consist preferably out of organic or inorganic light-emitting diodes. If it is, for example, intended to display television pictures on the media façade, then a first preferred version of this invention would utilize an inorganic LED construction style as lighting elements, which generate each of the three primary colors of a video pixel (red, green and blue) in each of the individual cells. These kinds of LED are referred to as RGB light emitting diodes. Transparent large-area display devices, in particular media façades, equipped with so-called RGB light emitting diodes and with suitable controls, are ideally suited for media projection, such as for example television pictures. In so-called RGB light emitting diodes, the primary colors of the television picture (red, green, and blue) are produced in each individual LED chip.

An alternative version of the invention consists of arranging three LED's very closely next to one another. One of these light diodes emits red light, another one emits green light, and the third diode emits blue light. The distance between these three diodes is in the range of 5 mm. For an observer who is located more than 1 m away from the display device, this appears like one point of light of a mixed color.

Particularly preferred are those lighting devices, i.e. light diodes, which can be controlled and supplied with electric power without notice for an observer, who stands at a large distance to the display. Especially suited for this are for example transparent strip conductors or conductor tracks, which have also been known from the EP-A 1 450 416 but also from the WO 2006/018066.

The disclosed content of the two scripts WO 2006/018066 and EP-A 1 450 416 are in their entirety included into the present application. The strip conductors or conductor tracks serve to supply electric power to the RGB light emitting diodes as well as to exert control over them. In this kind of arrangement the control line and the power line are the same, at least for one terminal. The other terminal can be attached to a bus bar.

It is particularly advantageous if the transparent strip conductors or conductor tracks consist of a transparent, electrically conducting and power transmitting layer. In this way it is possible to transmit higher electric currents through these strip conductors or conductor tracks, so that several lighting devices can be supplied through a single one of these strip conductors or conductor tracks. It is also preferable to build arrangements of strip conductors or conductor tracks, such that each light-emitting diode can be controlled separately in order to produce the intended pictures.

Next to strip conductors or conductor tracks with a transmission of ≧40%, in particular ≧60% in the spectrum of visible light, it is also conceivable to employ strip conductors or conductor tracks with a transmission of ≦40%, in particular ≦60%, when these strip conductors or conductor tracks are correspondingly small, i.e. kept at a very narrow width. Such strip conductors can be based on, for example, conductive silver paste.

The transparent and/or quasi-transparent element includes in particular at least one transparent and/or quasi-transparent substrate with lighting devices attached to it, whereby the transparent and/or quasi-transparent substrate is preferably in the shape of a pane. The transparent and/or quasi-transparent substrate can be, as previously mentioned, made out of plastic or glass, out of a crystalline or partially crystalline, out of a ceramic or partially ceramic material, in particular out of a ceramic glass. It would be conceivable to choose acrylic glass as a plastic substrate, or to use soda-lime glass, or gray glass, or a glass that is lean in iron, which holds preferably an iron oxide content of less than 0.05 weight %, preferably less than 0.03 weight %, as a glass substrate.

The transparent and/or quasi-transparent element can preferably include a cover pane, and it comprises thereby in particular a layered composite element. In general, there is a cover pane assembled together with the lighting devices on the transparent and/or quasi-transparent substrate.

The transparent and/or quasi-transparent element can include a casting resin layer, which makes it possible to mount the transparent and/or quasi-transparent substrate with the lighting devices directly to the façade, or to connect it to a cover pane, thus obtaining a multilayer glass pane composite. Alternatively to the connection with casting resin it is also conceivable to employ an adhesive film for this connection. Preferable for this are PVB (polyvinyl butyral) films, TPU (thermo-plastic polyurethane) films, PET (polyethylene terephthalate) films or EVA (ethylene vinyl acetate) films. The films, which are laminated into the multilayer glass pane composite, in between the transparent and/or quasi-transparent substrate with lighting devices and the cover pane, can also be a special film, for example a film that is coated with liquid crystals. Such a film that is covered with liquid crystals makes it possible to switch the state or condition of the film from not transparent or only very little transparent to one that is transparent, by applying a voltage. In this instance, as voltage is applied, the liquid crystals undergo a phase transformation and change from a fully disordered state, which make the film appear cloudy and dull, to an ordered phase which makes the film transparent and which allows visible light to transmit through the film. The film now appears transparent and looses its cloudy and dull look. The switchable film can cover the entire surface of the element or only a portion of it.

Alternatively, or in addition to a film that contains liquid crystals, a film can also be used which contains scatter centers. A film that contains such scatter centers is for example known from the DE-U-2 000 09 099 or from the DE-U-2 000 12 471. Films which contain scatter centers, for example a dispersion layer, are suitable to make projected light images visible in the region of the dispersion layer.

In order to enhance the contrast it is helpful to place a gray film in between the dispersion layer and one of the two multilayer composite glass panes.

If the dispersion layer is employed as a film with liquid crystals, as was described before, then the projection surface can be established by turning the switchable film with the liquid crystals to its cloudy and dull appearance. If nothing is projected onto the projection surface anymore, then the projection surface can be turned back into its transparent state.

Besides large-area displays using lighting devices in the form of LED's, these projection surfaces also permit the projection of pictures and in particular logos from the front and the back.

If the transparent and/or quasi-transparent element is constructed as a multilayer glass pane composite with at least two panes, then the lighting devices can be laminated into transparent film without any optical function, such as a PVB film, a TPU film, or a PTO film. In this context, a reference is made to WO 2004/106056. The disclosed content of this document is hereby included in its entirety into this patent application.

A transparent film, which equipped with lighting devices, for example with light-emitting diodes, is both transparent and electrically conductive, is for example already commercially available by Firma SUN-TEC Swiss United Technologies GmbH & Co., Rebenweg 20, 6331 Hünenberg, Switzerland. Such films that are equipped with LED's are both transparent and electrically conductive. The film equipped with LED's can also be cast together with a multilayer glass element using casting resin layer. It is also possible to build a laminate using adhesive film, such as PVB film, TRU film or EVA film.

The cover pane can be inorganic glass, silicate glass, preferably soda-lime glass, but also borosilicate glass, and in particular fire protective glass. But other glasses are possible choices for this cover pane.

In another particular version it would be possible to apply amorphous silicon, such as for example in the form of strips, onto the transparent substrate next to the light-emitting diodes. Together with the cover pane, a photovoltaic module is hereby produced in form of thin film technology, which towards the outside, remains transparent to light. Photovoltaic modules in thin film technology are for example the ASI Glass Modules of Firma SCHOTT Solar GmbH, Carl Zeiss Strasse 4, 63755 Alzenau. The solar energy that is collected by such a module can be stored and at a later time used to power the light-emitting diodes. In regard to thin film technology for solar applications, in particular in the context of photovoltaic modules, reference is made to EP 0 500 451 A. According to EP 0 500 451 A, a light transmitting photovoltaic cell of thin film technology is characterized by a transparent substrate, onto which a stack of thin layers is mounted, including a transparent layer of metal, a photovoltaic semiconductor transformation layer and one more metallic layer to generate photo-current.

Alternatively to this, the cover pane can be connected to the transparent and/or quasi-transparent substrate such that a gap is formed between the cover pane and the transparent and/or quasi-transparent substrate, resulting in the formation of a Double-Glazing-Unit (DGU) also known as an insulating glass laminate. For an insulating glass laminate it would be particularly possible to provide a thermal protection coating or a sun protective layer. For display devices, in particular for media façades, it is particular advantage if the strip conductors or conductor tracks are divided into several electric circuits in order to provide electric power for the lighting devices, and in particular in a way that each single lighting device can be controlled individually. In this way it is possible to generate video displays on large-area display devices, in particular on media façades. In this kind of application it is especially preferred if the individual RGB light emitting diodes are arranged in the manner of a matrix on the transparent substrate.

If the transparent substrate is separated from the cover pane by a gap, then the gap can also be filled with a medium, for example a cooling medium.

If an insulating glass laminate is formed, it is conceivable to employ a solar energy module in form of thin film technology, which allows light to be transmitted. In regard to solar modules, a reference is made to EP 0 500 451 A.

In order to prevent that the light-emitting diodes emit light into the interior of the building, in front of which the media façade is mounted, the light-emitting diodes can be shielded from the building. In particular, backwards emissions of the lighting devices into the buildings are supposed to be prevented in this way. Alternatively to shielding light-emitting diodes that emit in all directions, it is also conceivable to only employ light-emitting diodes that emit light in only one direction.

Shielding would be possible if the pads, which hold the individual light-emitting diodes, are spaced very close to one another on the transparent substrate. Alternatively, the entire transparent substrate can be blasted with sand or a minor effect can be applied where the light-emitting diodes are attached. It is furthermore conceivable to place mirror elements opposite from the light-emitting diodes in order to prevent light from being emitted into the building.

For the production of strip conductors or conductor tracks, in particular the production of transparent strip conductors or conductor tracks, the use of metal oxides is much preferred, for example ITO (InOₓ:Sn), FTO (SnOₓ:F) or ATO (SnOₓ:Sb). It is also conceivable to employ ZnOₓ:Ga, ZnOₓ:F, ZnOₓ:B, ZnOₓ:Al or Ag/TiOₓ. Especially preferred is FTO (SnOₓ:F), in particular SnO2:F, since this material can be utilized as a thermal protection coating in an insulating glass laminate. The utilization of SnO₂:F as a thermal protection coating is described in the publication “Dünnfilmtechnologie auf Flachglas” (Thin Film Technology on Flat Glass), by Prof. Dr. Hans Joachim Glaser, pp. 155-199, Verlag Karl Hoffmann, 1999, whose disclosed content is included in its entirety in this proposed patent application.

The application of the conductive layer onto the transparent substrate is preferably conducted by way of chemical vapor deposition (CVD) or by way of physical vapor deposition (PVD), by dip coating, spray coating, by chemical or electrochemical coating or by sol-gel coating.

Just to cite a few examples, reference is made to spray pyrolysis, sputtering as well as to the sol-gel process. The application via spray pyrolysis is particularly cost effective, whereby SnO₂:F, SnOₓ:F and ZnOₓ:F, respectively, are the preferred coating materials. If particularly good optical properties are intended one would prefer sputtering as the application process of choice.

Alternatively to this, it is also possible that the conductive layer is a metal, such as for example Al, Ag, Au, Ni, or Cr, which are either vapor deposited or sputtered onto the surface and which are as a general rule, quasi-transparent. Metallic surfaces are particularly preferred if the manufactured component is employed at elevated ambient temperatures.

The strip conductors or conductor tracks can also be printed onto the transparent and/or quasi-transparent substrate as electrically conducting microlines, for example Silver.

In this present application, the transparent conductive layers are layers with a transmission of ≧$40%, preferably with a transmission of ≧60%, particularly preferred with a transmission of ≧70%, but especially preferred with a transmission of ≧80% in the visible spectrum of light.

In order to ensure that systems retain their low reflectivity, a progression of this invention proposes that a special reflective layer is applied onto the conductive layer, such as for example TiO₂, SiO₂, or a mixed layer of Ti₂Si₁₋ₓO₂.

Preferably, this transparent element includes an anti-reflection layer in order to permit an unobstructed view through the element. Such a highly anti-reflective coating for glass is, for example the highly anti-reflective glass AMIRAN® of the Schott AG, in Mainz. AMIRAN® is interference optically dip coated with an anti-reflective coating on both sides, and as such displays a residual reflectivity of less than one percent. By using glass with a highly anti-reflective coating, the overall reflectivity can be reduced by ⅛, hereby making the element exceptionally transparent.

By utilizing these kinds of glasses, any kinds of undesirable reflections can be almost completely eliminated.

The electrically conducting layer out of a metal oxide or out of a metal can be structured in the manner of a matrix or in any other desirable way. This in turn permits the application of a very structure onto the transparent substrate. This, again, permits the application of a complete electronic circuitry on one and the same transparent substrate. Structuring the electrically conductive layer can be achieved after the layer is applied, by intentionally removing targeted areas of the coating, for example by use of a laser, which locally heats up the layer and thus causes the coating to evaporate. When using a laser to apply an intended structure to a once completely coated area it is of particular usefulness if the coating has a particularly high absorptivity of the wavelength emitted by this particular laser while the substrate, in turn, should be as transparent as possible to the wavelength of this particular laser. For a system of this sort, almost the entire energy is absorbed by the conducting layer, while hardly any damages should incur to the glass surface. For a system of this particular kind cracks on the surface of the glass should be avoidable.

Alternatively to this method, structuring the coating applied to the complete surface area is also possible by use of lithography followed by a subsequent etching process.

Structuring is also conceivable if during the coating process, for example during vapor depositing, photo mask techniques are employed to immediately apply the intended final structure to the strip conductors or conductor tracks.

It is also conceivable to apply structures to strip conductors or conductor tracks out of silver layers, for example out of conductive silver lacquer. The conductor tracks out of conductive silver lacquer are not necessarily themselves transparent, but they are shaped such that they are inconspicuous to a distant observer. Such an effect is attainable if the individual conductor tracks are shaped accordingly small, i.e. possess a very narrow width.

It is especially preferred if the strip conductors or conductor tracks can be made out of electrically very conductive layers, which can be structured by use of lasers, in particular so called highly conductive layers, in particular out of a metal oxide, in particular out of SnOₓ:F, preferably out of SnO₂:F. Highly conductive layers, in particular those including SnOₓ:F, have a surface resistance ≦15 Ohm/square [Ω/cm²], in particular ≦10 Ohm/square [Ω/cm²], preferably ≦8 Ohm/square [Ω/cm²], especially preferred ≦7 Ohm/square [Ω/cm²], especially preferred ≦5 Ohm/square [Ω/cm²] for a layer thickness of about 500 nm.

It used to be common that the surface resistance associated with transparent substrates coated with SnOₓ:F, but preferably with SnO₂:F was more than 15 Ohm/square [Ω/cm²] for layers of a thickness of about 500 nm.

The layer thicknesses of these highly conductive layers are preferably more than 150 nm, preferably more than 180 nm, particularly preferred more than 280 nm, particularly preferred more than 420 nm, particularly preferred more than 500 nm, particularly preferred more than 550 nm. The transparency of such layers, meaning the transmission of a wavelength of 550 nm, is more than 82%, in particular more than 87%, in particular more than 89%.

In order to connect the light-emitting diodes or other electronic components on the carrier substrates, a particularly preferred version of this invention uses electronic connector points, so called electronic pads, to mount them onto the electrically conducting layer or onto a strip conductor or a conductor track made out of a highly conductive material. Such electronic connector points include a conducting paste or lacquer, for example a conductive silver lacquer or a conductive silver lacquer paste. The mounting of these electronic connector points can be achieved by screen printing or by printing using a template followed by subsequent curing (or baking), whereby in case of using glasses as a substrate, such a process serves at the same time to pre-stress these glasses. The advantages of a component that has been produced in this manner are that it can produce particularly toughened glasses and that it doesn't require any additional steps in the manufacturing process to achieve this. Another advantage consists in that the mounting of the electronic pads opens up the possibility of soldering onto the transparent substrate. Alternatively to connecting via soldering onto strip conductors or conductor tracks, there's also the possibility to use glue. In comparison to glued connections, the soldered connections are stronger, more stable over time and less sensitive to environmental impact, such as for example humidity, heat or chemicals, etc.

According to another advantageous version of this invention, the attaching of the lighting devices, in particular of the light-emitting diodes, does not take place on the transparent and/or a quasi-transparent substrate, for example by gluing them on, but is achieved indirectly. The indirect approach begins as previously described, by first mounting electronic connector points, so-called electronic pads, onto the transparent and/or a quasi-transparent substrate. Subsequently the lighting devices, in particular light-emitting diodes are soldered onto the electronic pads.

If none of these nearly invisible strip conductors or conductor tracks are made out of a transparent, for example highly conductive material, but instead out of thin conductive silver lacquer, then the conductive silver lacquer as well as the electronic pads can be produced via screen printing or via a dosing process. In the dosing process the conductive silver paste is applied by a dosing device. The silver strip conductors can also be applied to the transparent substrate using the ink jet technique, for example by ink jet printing.

Another option would be to apply thin wires, preferably thin metal wires.

In order to connect the building components or the lighting devices or light-emitting diodes, respectively, with the conducting layer of the carrier substrate through the electronic connector points, then the fitting of the light-emitting diodes onto the carrier substrate is realized with a standard method that is well known from the electronics industry, whereby for example soldering paste is applied using a template onto the individual electronic connector points, or so called electronic pads. Subsequently the light-emitting diodes are placed onto them on the carrier plate. This can be achieved with a chip bonder, which can mount the individual lighting devices prior to the soldering process onto the support material. After the individual lighting devices are all properly mounted, the carrier substrate is sent through a wave soldering bath. Alternatively the LED's, which are applied using a chip bonder, can be sent through a wave soldering bath. The soldering process and the indirect placement has the decided advantage that on one hand, this is a relatively simple process, and that on the other hand, after the LED's are mounted, the carrier substrates can be washed.

But it is also possible to mount a conducting adhesive, via screen printing or via a printing process using a template onto the carrier substrate, so that the lighting devices or other electronic components are directly applied to the carrier substrate. It is possible to employ an isotropically conducting adhesive as well as an anisotropically conducting adhesive. If the strip conductors or conductor tracks are spaced very closely to one another, then the use of anisotropically conducting adhesives is preferred. A clear disadvantage to a direct application using adhesives is the need for expensive preparations, which generally requires clean room conditions.

The particular advantage of this proposed invention is the readiness with which it can apply any desired structure. This allows that not only lighting devices, such as for example light-emitting diodes, can be applied as in the current state of technology to the carrier substrate, but it also allows the same for other electric or electronic components. This applies to all currently known electric or electronic components, such as for example sensors, discrete semiconductors, passive and active components, resistors, capacitors, coils, loud speakers, interactive components such as keyboards, etc.

The interactive components allow, for example, the display and recall of data pertaining to customers. Loud speakers allow the play back of sound data in addition to, for example the display of graphic information. It is also possible in some areas to exert control over an LC film (electroluminescent layer for liquid crystal display) through the conductive layer. If not the entire area that was covered with coating needs to be mounted with light-emitting diodes, then it is possible to apply all of the electronic controls or parts of the electronic controls on the carrier substrate. This is of particular advantage if the display device is employed as a large-area video display device. Large-area video display devices, which are designed according to this proposed invention, include more than 1,000, in particular more than 5,000, preferably more than 10,000 individual lighting devices, particularly preferable more than 100,000 lighting devices, preferably more than 250,000 individual lighting devices, and particularly preferable more than 1000,000 lighting devices.

The large-area video display devices, in particular the large-area media façades with a number of light-emitting diodes previously stated, are preferably structures, such that for example more than 80, in particular more than 100, preferably more than 200, preferably more than 500, particularly preferable more than 750, and particularly preferable more than 1,000 or more individual light-emitting diodes are associated with an electronic control, whereby the control electronics are preferably arranged on the transparent substrate. This is particularly possible if not the entire substrate is equipped with lighting devices. It is for example not possible to utilize the edge region of the substrate.

In this particular case it is possible to arrange the individual electrical leads so they go from one of the light-emitting diodes to this particular edge region of the optical element. It is there that the individual electrical leads of the light-emitting diodes can converge with a bus bar, which runs along this edge region, and which supplies the individual light-emitting diodes with electric power. This ensures that only very few electric leads emerge out of the transparent substrate.

The large-area display devices, which are designed according to this proposed invention, include display surface areas of more than 10 m², in particular more than 50 m², particularly preferred more than 100 m², particularly preferable more than 1,000 m², particularly preferable more than 3,000 m², and particularly preferable more than 5,000 m². As an example, there will be about 400,000 LED's distributed over a media façade with a display surface area of 4,000 m². Since it is not possible to produce transparent substrates of this size, these large-area media façades are composed in a modular fashion out of transparent elements that are put next to one another, and where each consists out of one transparent substrate, each of which being produced according to this invention. The modular construction of the transparent elements makes it possible to build display areas of any desirable size.

The advantage of the electronic components and power supplying lines, respectively, which are mounted on the transparent substrate, is provided, especially when RGB light emitting diode chips are employed, as the costs and complexities of wiring are much less than compared to the current state of technology. The individual LED's are preferably not directly mounted onto the substrate, for example by gluing, but rather indirectly. To facilitate this, so-called connection pads, including an electrically conductive paste or lacquer, for example conductive silver lacquer or conductive silver paste, are applied to the substrate.

In another preferred version of this invention, not only individual electric or electronic components, such as for example coils or capacitors, are applied to the carrier substrate, but also additionally printed circuit boards or hybrid circuits with complete integrated circuitries, which can, for example, include electric power sources or electric power controls. It is furthermore also possible to mount active elements, such as for example loud speakers onto the carrier substrate. This is of particular relevance when RGB light emitting diodes are employed.

Another preferred version of this invention envisioned for the construction of transparent elements for a media façade uses a second transparent substrate in order to protect the lighting devices. The light-emitting diodes are in this case located in between the transparent carrier substrate and the other transparent substrate. In this instance the light sources can be additionally protected from environmental effects, such as humidity or mechanical shearing.

In yet another preferred version of the proposed invention it is envisioned that the other transparent substrate is also applied with a conductive transparent layer.

The transparent substrate can be a glass substrate as well as a plastic substrate. Especially preferred is when the glass substrate is hardened and pre-stressed. Especially preferred for these glasses are soda-lime glasses.

In another preferred version of this invention it is envisioned that several carrier substrates equipped with lighting devices, such as for example light-emitting diodes, be connected with one another and to suitably electrically contact them with one another.

It is especially advantageous if the transparent element for a media façade according to this proposed invention is a glass composite, for example an insulating glass composite. An insulating glass composite is also referred to as a Double-Glazing-Unit (DGU). A Double-Glazing-Unit (DGU) or insulating glass element is a glass element that is particularly utilized in architectural applications, which is composed out of two glass elements that are spaced at a distance from one another. At least one of these glass elements incorporates the transparent element which is equipped with one or more lighting devices. The gap or gaps that are formed between at least two of the glass elements, which are spaced from one another at a distance and which comprise the Double-Glazing-Unit (DGU), can be filled with a medium. This medium can be either in form of a gas or in the form of a liquid and it can, for example, serve for cooling purposes.

The one element, which includes the transparent element and several lighting devices, can be either a single pane glass, a single pane tempered safety glass, or a pre-stressed single pane glass. It is furthermore a possibility that the transparent element, as described before, is part of a glass composite, for example a safety glass composite, which could include either a single pane safety glass as well as a pre-stressed glass. With glass composites there is the possibility that the light-emitting diodes are either attached directly onto the conducting coating, which in turn is applied to one pane of the glass composite, or it is in a film, which is located in between the two panes. The first element can furthermore be a special glass, such as for example a glass with a highly anti-reflective coating, a heat protective glass, a sun protective glass or a fire protective glass. The first element can furthermore also include light transmitting concrete or a ceramic glass.

The second element of the insulating glass composite, which is spaced at a distance to the first element, can again be either a single pane glass, a single pane tempered safety glass, or a pre-stressed single pane glass, a safety glass composite, a safety glass composite, which includes a single pane safety glass, and a safety glass composite, which includes a pre-stressed glass or a special glass such as a glass with a highly anti-reflective coating, a decorative glass, a solid colored glass, a color effect glass with an interference optical coating, a heat protective glass, or a sun protective glass. The second element of the insulating glass composite can furthermore also be a fire protective glass or light transmitting concrete.

The distance between the two elements, in particular for an insulating glass element, is ensured with a spacer element, for example with a metal spacer element as well as a sealant between the two opposing elements that comprise the insulating glass composite. The distance between the two opposing surfaces of the insulating glass composite is somewhere between 5 mm and 50 mm, preferably in the range of 10 mm up to 30 mm. Besides the spacer element, and in order to seal the spacer element against the pane shape element, sealant materials are envisioned, preferably out of butyl rubber.

In this context, the term pane shape refers to flat as well as to a curved pane shape elements. A pane shape element according to the proposed invention has an area that is 10 times larger than the thickness of the pane itself.

The second element, which as previously described cannot include the light-emitting diodes, can be in many different forms and adaptations. It is, for example possible in a first adaptation of the second element, to employ the highly anti-reflective glass AMIRAN® of the Schott AG, which reduces the overall reflections to one eighth of glasses that were not treated with any anti-reflective coating. In the same manner, it is possible to employ color effect glasses, such as the color effect glass NARIMA® of the Schott AG, which functions on the basis of an interference optical effect. The second optical element could furthermore include a solid colored glass, such as for example the glass IMERA® of the Schott AG, which has an unstructured surface, or a solid colored glass, such as for example the glass ARTISTA® of the Schott AG, which has a structured surface on one side. It is of course also possible to use a glass as the second optical element in the insulating glass composite, which is transparent in the visible spectrum of light, but that includes a printed or a sand-blasted surface. It is of course not necessary that the entire surface of the pane, which is opposing the transparent optical element equipped with lighting devices, be structured, or covered with anti-reflecting coating, or be a color effect glass or a decorative glass. It is much more possible to only have parts of the glass, which is opposing the element equipped with light-emitting diodes, to be treated or equipped in that way.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a section of a transparent substrate for a transparent element of a media façade, with lighting devices arranged on the transparent substrate;

FIG. 2 is the typical sequence of processes to produce a transparent substrate with lighting devices for structuring by use of a laser;

FIG. 3 is a section of a transparent substrate for a transparent façade element;

FIG. 4a is a first version of a transparent façade element with several substrates equipped with light-emitting diodes, which are stacked behind one another;

FIG. 4b is a second version of a transparent façade element with several substrates equipped with light-emitting diodes, which are stacked behind one another;

FIG. 4c is a third version of a transparent façade element with several substrates equipped with light-emitting diodes, which are stacked behind one another;

FIGS. 5a-5f are different glass units, in particular insulating glass units with at least one transparent element and/or quasi-transparent element, which holds the lighting devices, and one other optical element;

FIG. 6 is a multimedia façade;

FIGS. 7a-b are a section view and a top view, respectively, of a first version of two façade elements connected to one another;

FIG. 7c is second version of two façade elements connected to one another; and

FIG. 8 is an example of a fixture to mount a transparent element on to a façade.

Corresponding reference characters indicate corresponding parts throughout the several views. The exemplifications set out herein illustrate embodiments of the invention, and such exemplifications are not to be construed as limiting the scope of the invention in any manner.

### DETAILED DESCRIPTION OF THE INVENTION

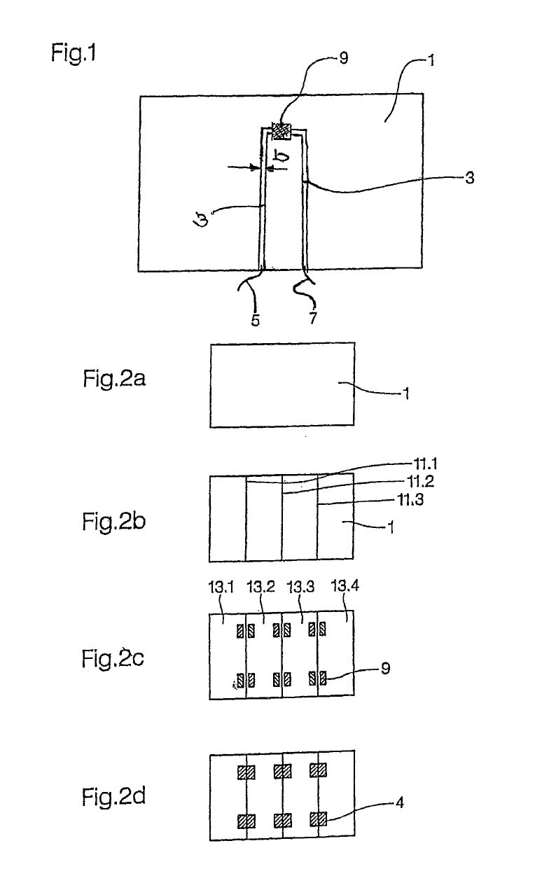

Referring now to the drawings, and more particularly to FIG. 1, there is shown a transparent or quasi-transparent substrate, which functions as carrier substrate for light-emitting diodes as part of a transparent element, such as for example for a media façade, with an electrically conductive layer that is applied onto this transparent substrate 1 and structured in such a way that strip conductors or conductor tracks 3 are formed on this transparent substrate 1. A plurality of individual electronic connector points 9 are arranged on the strips conductors or conductor tracks 3 of which one is shown. The purpose of these electronic connector points 9 is to electrically connect the individual lighting devices, such as for example light-emitting diodes, in particular RGB light emitting diodes (not shown) to the strip conductors or conductor tracks 3 and thereby provide electric power to them. These strip conductors or conductor tracks 3, which are made for example out of ITO (InOₓ:Sn) or FTO (SnOₓ:F), have a width b, which is in the range of a few mm. A preferred carrier substrate is envisioned to be out of a soda-lime glass.

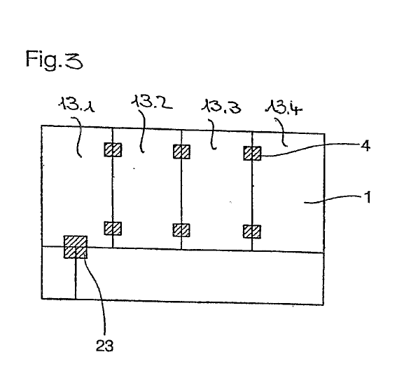

FIGS. 2a through 2d illustrate a process according to this proposed invention to produce a transparent substrate to hold lighting devices for a transparent element of a multimedia façade. To begin with, the entire surface of a transparent substrate 1 is completely coated with an electrically conducting layer, for example by using the sol-gel process.

In a following step according to FIG. 2b, a structure is established, for example by using a laser, to locally heat up the coating and cause it to evaporate. In this manner it is possible to produce large-area conducting regions as well as individual strip conductors or conductor tracks. In this context it is preferred that the carrier substrate, which is structured by use of a laser, include an electrically conductive layer which has a high absorption of the wavelength of the laser that is employed, and a substrate, which is transparent to the laser light of this particular wavelength. In such a system, the glass layer will only incur minor damages. Such a system permits in particular that cracks can be for the most part avoided. The conductive layer in this context is particularly preferable out of a highly conductive metal oxide, such as previously described. Materials of such a highly conductive layer can include one or more of the following metal oxides:
InOₓ:Sn
SnOₓ:F
SnOₓ:Sb
ZnOₓ:Ga
ZnOₓ:B
ZnOₓ:F
ZnOₓ:Al
Ag/TiOₓ

The highly conductive layer has a thickness of about 500 nm and a preferred layer resistance of R≦15 Ohm/square [Ω/cm²], in particular R≦10 Ohm/square [Ω/cm²], preferably R≦9 Ohm/square [Ω/cm²], especially preferred R≦7 Ohm/square [Ω/cm²], especially preferred R≦5 Ohm/square [Ω/cm²].

The thicknesses of these highly conductive layers are preferably more than 150 nm, preferably more than 180 nm, particularly preferred more than 280 nm, particularly preferred more than 420 nm, particularly preferred more than 500 nm, and very particularly preferred more than 550 nm. The transparency of such layers of a wavelength of 550 nm is more than 82%, in particular more than 87%, in particular more than 89%. It is of advantage if these highly conducting layers are SnOₓ:F-, or SnOₓ:Sb-, or ZnOₓ:F-layers. An advantage of SnOₓ:F, in particular of an SnO₂:F-layer, is that it is not only a conducting layer, but that it also functions as a thermal barrier coating.

The separating lines between the individual regions on the substrates are designated with the reference numbers 11.1 through 11.3 in FIG. 2b. Following the structuring according to FIG. 2b, individual electronic connector points, so called electronic pads 9, are applied in the regions 13.1 through 13.4. The electronic pads 9 include a conducting paste or lacquer, for example a conductive silver lacquer or a conductive silver lacquer paste, which are applied by screen printing or by printing using a template, followed by subsequent curing (or baking). The curing process serves at the same time to pre-stress the transparent substrate, in particular the transparent glass substrates. This process achieves particularly high mechanical strength levels in a single step. Alternatively to screen printing or printing with a template the solder can also be applied with a dosing process.

After the contacts are applied in the various regions 13.1 through 13.4, as depicted in FIG. 2d, they are fitted using a standard process, whereby for example soldering paste is applied to the electronic pads 9, for example by using a printing template. The light-emitting diode (LED's) 4 are then applied to the carrier plate, whereby a chip bonder can be utilized, which attaches the light-emitting diodes 4 before beginning the soldering process on the carrier material. After the individual light-emitting diodes are attached, the carrier plate 1 with the light-emitting diodes attached to it are sent through a reflow oven or through a wave soldering bath.

In one particular version of the proposed invention, a glass substrate, typically a soda-lime glass, is coated with a tin oxide doped with fluorine (SnOₓ:F). The application of this coating can be achieved as follows:

A soda-lime glass as a transparent substrate is heated up to 500° C. Following this the glass is sprayed with monobutyl tinchloride and hydrofluoric acid (HF) in ethanol, where the sprayed solution is of the following composition:

| | |
|---|---|
| Monobutyl tinchloride | 70% |
| Ethanol | <30% |
| Hydrofluoric acid (HF) | 0.4% |

After spraying, the soda-lime glass comprises a transparent layer of tin oxide doped with fluorine.

The coating is then with a laser separated into individual regions such as strip conductors or conductor tracks. With the help of a squeegee, a conductive silver paste, such as for example Cerdec SP 1248, is applied by screen printing. The paste Cerdec SP 1248 is then dried in a conveyor furnace at 140° C. for about 2 minutes, and then cured and pre-stressed through a pre-stressing apparatus at about 700° C. for soda-lime glass. Subsequently the commercial grade soldering paste is applied via printing with a template and then the light-emitting diodes are fitted. During the following reflow soldering the fitted substrate is preheated for 2 minutes at 120° C. and then for 5 seconds heated up to 235° C. Following this step, the fitted substrate is slowly cooled down.

The preferred light-emitting diodes for this are so called RGB light-emitting diodes (RGB-LED's). RGB light-emitting diodes are light-emitting diodes that generate all three of the primary colors of a video pixel, i.e. red, green and blue, in each individual cell. With the help of such diodes it is very easily possible to produce moving pictures, such as for example television pictures, on a multimedia façade. In this context, it is preferred that each of the RGB light-emitting diodes are individually controlled, so that with the help of a computer, for example moving television pictures can be generated on a media façade.

It is preferred that the RGB light-emitting diodes on the transparent element, which is fitted as a carrier substrate, form a regular pixel pattern.

It is of course also conceivable that the media façade is equipped with simple light-emitting diodes that create illuminated patterns, which can then, for example form moving or changing pictures.

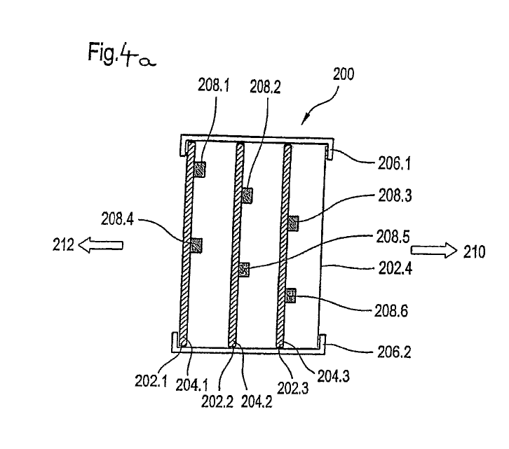

FIG. 3 depicts an adaptation of the proposed invention, where a transparent element, which includes a carrier substrate 1, is structured into different regions 13.1, 13.2, 13.3 and 13.4. These regions can hereby be regarded as strip conductors or conductor tracks, whereby light emitting diodes 4 are applied onto or against the strip conductors or conductor tracks with the help of the procedure depicted in FIGS. 2a-2d. Besides the light-emitting diodes 4, which are preferably in the form of RGB light-emitting diodes, the carrier substrate also contains further electronic components, such as for example computer chips 23 that can facilitate individual control of the RGB light-emitting diodes 4.

Alternatively to connecting all the light-emitting diodes with a coating that is applied to the entire surface of the substrate and subsequently structure the coating into strip conductors or conductor tracks to thus form a transparent and conductive substrate, an alternative technique is conceivable whereby the individual strip conductors or conductor tracks are applied very thinly, for example by using a screen printing process or an ink jet process. Strip conductors or conductor tracks that were applied using a screen printing process or an ink jet process can be thin silver strip conductors, which are applied so thinly that they remain unnoticed to a distant observer. It is also conceivable to connect the individual light-emitting diodes or light-emitting diode chips with the help of very thin wires.

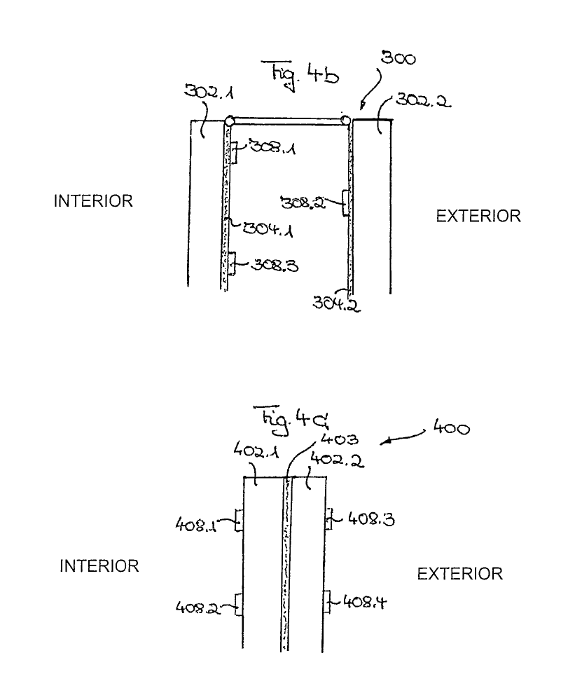

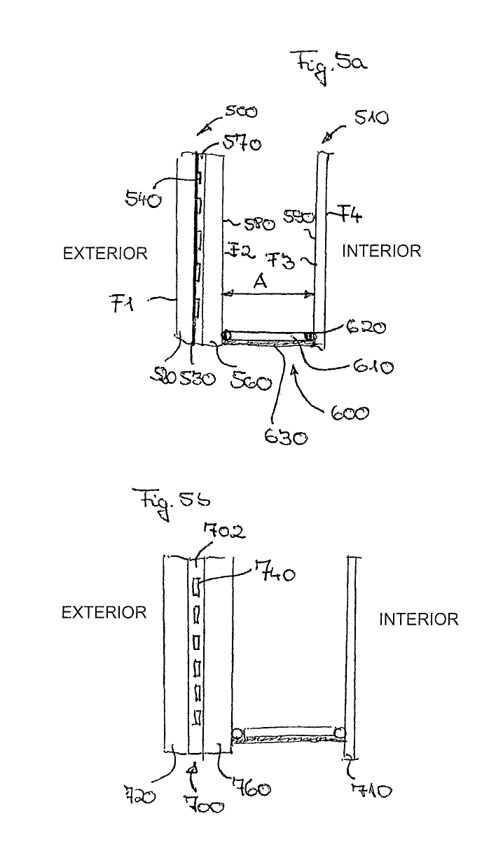

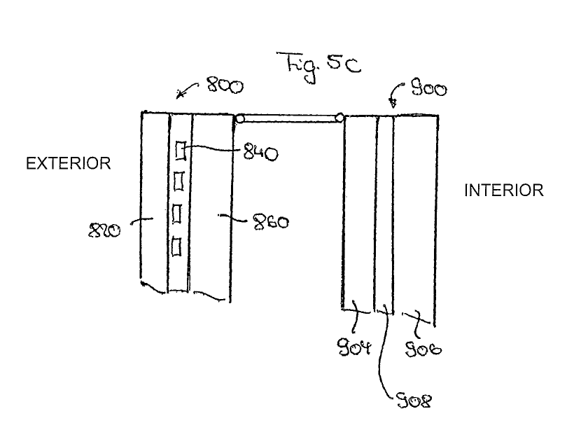

FIG. 4a depicts yet another version of the proposed invention. In this version of the invention it is proposed that instead of using light-emitting diodes, in the form of so called RGB light-emitting diodes that are attached onto a single carrier element, to use several transparent substrates stacked behind one another to comprise the transparent element for the media façade, whereby different substrates are equipped with light-emitting diodes that emit different colors of light. The proposed version depicted in FIG. 4a shows the transparent element 200 that can be employed on a façade and which includes four substrates, in this case the four transparent panes 202.1, 202.2, 202.3 and 202.4, which are stacked behind one another. These transparent substrates 202.1, 202.2, 202.3 and 202.4 are substrates, which are coated with an electrically conductive layer 204.1, 204.2 and 204.3. These electrically conductive layers are structured, for example by using laser structuring, so that strip conductors or conductor tracks are put in place to the respective lighting devices, in this case light-emitting diodes 208.1, 208.2, 208.3, 208.4, 208.5 and 208.6. The transparent pane 202.4 is the cover pane for the element 200. The element 200 is being kept together by clamps 206.1 and 206.2. It is also conceivable to cast the individual panes together into a multilayer glass pane composite, such as for example with a casting resin or an adhesive film. The light-emitting diodes 208.1, 208.2, 208.3, 208.4, 208.5 and 208.6 located on the different substrates 202.1, 202.2, 202.3 and 202.4 are arranged in a staggered fashion with respect to one another, but all of them are emitting light into the same direction, so overall a lot more light is emitted in the direction 210 than in the direction 212. The direction 210 is the preferred direction of emission. If the multilayer glass pane composite includes a film, then the light-emitting diodes cannot only be applied onto the substrate itself, but can also be in the film.

It is also conceivable that the light-emitting diodes of the different substrates can emit light of different wavelengths, so that displays of different colors are possible, such as with the RGB light-emitting diode chips. It is for example possible that the light-emitting diode 208.1 is a light-emitting diode emitting red light, while the light-emitting diode 208.2 is a light-emitting diode emitting green light, and while the light-emitting diode 208.3 is a light-emitting diode emitting blue light. The light-emitting diodes can also be individually controlled, if for example the strip conductors or conductor tracks for each light emitting diode each extend individually out of the element. In this case it is possible, even with a set up depicted in FIG. 4a, to produce running pictures or changing pictures for a media façade.

FIG. 4b shows an alternative version of an element, where several transparent substrates with light-emitting diodes are stacked behind one another.

The adaptation of the invention depicted in FIG. 4b depicts the transparent element 300, which is employed in service as a façade element, and which includes altogether two substrates, the panes 302.1 and 302.2, which are stacked behind one another.

Just as in FIG. 4a, the two panes 302.1 and 302.2 are connected with one another, for example by use of clamps, or as it is common with multilayer glass pane composites, with sealing elements. Contrary to the adaptation depicted in FIG. 4a, it is envisioned for the adaptation in FIG. 4b to apply the electrically conducting layers 304.1 and 304.2 on the interior surfaces of the two panes 302.1 and 302.2, which are the surfaces facing the gap that is formed in between these two panes. It is especially preferred if the light-emitting diodes 308.1 and 308.2 that are applied to the electrically conducting layers 304.1 and 304.2 are opposing one another but at the same time staggered with respect to one another.

If the façade element depicted in FIG. 4b is employed such that the interior side, denoted INTERIOR, is facing towards the building and the exterior side, denoted EXTERIOR, is facing outward away from the building, then it is preferred that the lighting devices 308.1 and 308.3 emit light outwardly and it is preferred that the lighting devices or light emitting diodes, respectively, 308.2 emit light backwards, through the pane 302.2, also outwardly, towards EXTERIOR, i.e. away from the building.

In order to not allow any light to enter into the building, it can be envisioned to apply an absorbing material or a reflecting material on the back face of the pane 302.1, so that any light that is shining in the direction of the building is reflected back into the outward direction.

It is also conceivable for the element that is depicted in FIG. 4b, that a noble gas can be filled into the gap that is formed between the two panes 302.1 and 302.2, such as it is customary with an insulating glass element, or to fill this gap with a filler material, such as for example a filler medium, for cooling purposes.

FIG. 4c depicts another alternative adaptation of the proposed invention, where a plurality of transparent substrates, which are stacked behind one another, is each fitted with a plurality of light-emitting diodes. Contrary to the adaptations depicted in FIGS. 4a and 4b the elements are not spaced apart from one another, but instead the adjacent panes are connected to a composite, such as for example with a casting resin. The element 400 includes two panes 402.1 and 402.2. These panes are preferably envisioned as transparent substrates, but they can also be envisioned as quasi-transparent panes. The panes 402.1 and 402.2 are connected to one another, for example with a casting resin 403 that has been inserted between the panes 402.1 and 402.2. Instead of using a cast resin 403, it is also conceivable to insert a film between the panes 402.1 and 402.2, for example a PVB film or an EVA film, or some other adhesive film. It is furthermore conceivable to insert functional films between the two elements, such as for example LCD films or dispersion films. There are light-emitting diodes attached to each of the transparent or quasi-transparent substrates 402.1 and 402.2. Once again, it is preferred that these are staggered with respect to one another. If the element is employed on a façade such that the interior side, denoted INTERIOR, is facing towards the building and the exterior side, denoted EXTERIOR, is facing outward, away from the building, then it is preferred that the lighting devices 408.1 and 408.3 emit light outwardly, away from the building, and it is preferred that the lighting devices or light emitting diodes, respectively, 408.3 and 408.4 emit light backwards through the transparent substrates 402.1 and 402.2, also outwardly, i.e. away from the building. The light-emitting diodes can be preferably envisioned as light-emitting diodes that emit light into one direction. Light-emitting diodes that emit into two directions are also conceivable. If the light-emitting diodes are of the sort that emits light into two directions, then it is conceivable to reflect the light, which is emitted inwardly, i.e. towards the façade, back towards the outside by use of appropriately mounted reflectors.

The lighting devices, in particular the light-emitting diodes, can be mounted on the electrically conductive coating that was applied on a pane of the layered glass composite, or it can be in a film which is being inserted in between two of such panes.

The second element of the insulating glass composite, which is spaced at a distance to the first element, can again be either a single pane glass, a single pane tempered safety glass, a safety composite glass, a safety composite glass, a pre-stressed single pane glass, a safety glass composite, a safety glass composite that includes a single pane glass and a safety glass composite and a safety glass composite that includes a pre-stressed glass.

The distance between the two elements, in particular for an insulating glass element, is ensured with a spacer element, for example with a metal spacer element as well as a sealant between the two opposing elements that comprise the insulating glass composite. The distance A between the two opposing surfaces of the insulating glass composite is somewhere between 5 mm and 50 mm, preferably in the range of 10 mm up to 30 mm. Besides the spacer element, and in order to seal the spacer element against the pane shape element, sealant materials are envisioned, preferably out of butyl rubber.

The second element, which does not include the light-emitting diodes, can therefore be in many different forms and adaptations. It is, for example possible in a first adaptation of the second element, to employ the highly anti-reflective glass AMIRAN® of the Schott AG, which reduces the overall reflections to one eighth of glasses that were not treated with any anti-reflective coating. In the same manner, it is possible to employ color effect glasses, such as the color effect glass NARIMA® of the Schott AG, which functions on the basis of an interference optical effect. The second optical element could furthermore include a solid colored glass, such as for example the glass IMERA® of the Schott AG, which has an unstructured surface, or a flat, solid colored glass, such as for example the glass ARTISTA® of the Schott AG, and which has a structured surface on one side. It is of course also possible to use a glass as the second optical element in the insulating glass composite, which is transparent in the visible spectrum of light, but that includes a printed or a sand-blasted surface. It is of course not necessary that the entire surface of the pane, which is opposing the transparent optical element equipped with lighting devices, be structured, or covered with anti-reflecting coating, or be a color effect glass or a decorative glass. It is much more possible to only have parts of the glass, which is opposing the element equipped with light-emitting diodes, be treated or equipped in that way. The transparent element with lighting devices, for example a transparent substrate with lighting devices, can also be employed in glass composites, in particular in insulating glass composites. For glass composites there is at least one further element spaced apart from the transparent element with lighting devices attached to it, or being connected via a spacer, respectively. Between the other element and the transparent element with lighting devices is either a vacuum or a filler gas, in particular a noble filler gas such as for example Argon.

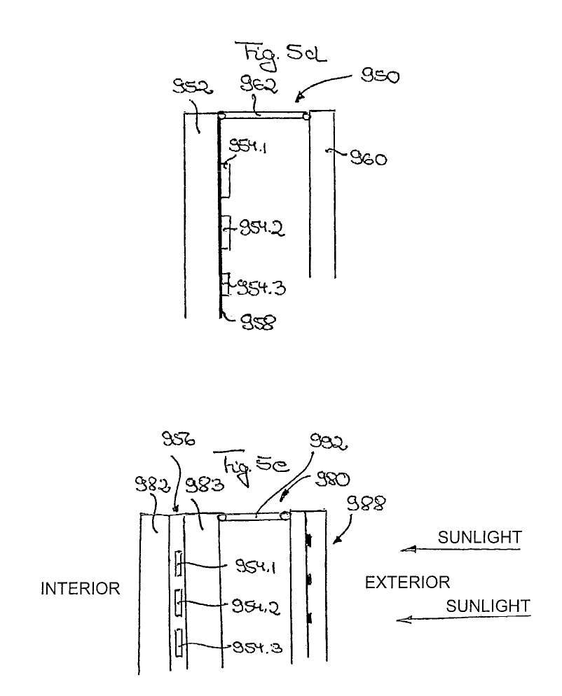

FIGS. 5a through 5f depict elements which consist out of at least one transparent or quasi-transparent substrate and one additional element. The additional element can also be a decorative glass. The elements depicted in FIGS. 5a through 5f are preferably insulating glass elements with one gap.

The insulating glass element according to the first adaptation depicted in FIG. 5a consists of one glass composite element 500 as well as one monopane 510. The glass composite element 500 consists of one transparent substrate 520 with an electrically conductive coating 530 that has been applied onto it. Lighting devices 540 are arranged onto the electrically conductive coating, for example by the use of soldering pads. Facing the side of the substrate that is coated with the electrically conductive layer is a second pane 560, which covers the transparent substrate. A casting resin layer 570 is applied into the gap between the transparent element that is coated with the electrically conductive layer and the mating second pane, in order to create a composite glass element. The composite glass element can also be created in such a way, that a film that can hold, for example the lighting devices and that could be inserted in between these panes, i.e. in between the transparent substrate and the mating second glass pane. The film with the lighting devices is laminated together with other films in between these two panes. The other films can also be films with special functions, such as for example a film with liquid crystals that can be switched from one state or condition to another.

It is also conceivable instead of employing a film that contains liquid crystals, to insert a film that contains scatter centers to facilitate, for example a projection surface that would allow projections from the front or the back. The distance A between the two interior surfaces 580 and 590 of two elements 500 and 510, in this present case between the multilayer glass pane composite 500 and the single pane elements 510, is somewhere between 55 mm, preferably in the range of 10 mm up to 30 mm, in particular of 16 mm. The distance between the two elements, in particular for an insulating glass element, is ensured with a spacer element, for example with a metal spacer element, preferably out of aluminum. The spacer element 610 is sealed against the pane shape element by use of a sealing element 620, which is preferably made out of butyl rubber. The complete seal of the gap between the first and second pane shape is achieved with butyl rubber 630 that is applied underneath the spacer element 610. In the gap between the first pane shape element 500 and the second pane shape element 510 is preferably a gaseous medium. For more challenging thermal requirements the medium employed could be particularly a noble gas. This noble gas medium could include, for example the elements Argon or Xenon or Krypton. In addition, FIG. 5a depicts the surfaces that are characteristic for an insulating glass element, as well as the surfaces of the façade that face the outside, i.e. the weather side, as well as the inside, i.e. the side facing the building. The composite glass element that faces towards the outside includes surfaces F1 and F2, while the monopane that faces towards the building, includes the surfaces F3 and F4.

In order to obtain a particularly transparent element, it is conceivable to apply an anti-reflection layer, for example onto the surface F4, as it is, for example with the flat glass AMIRAN®. It is furthermore conceivable to apply to the surfaces F2 and F3 thermal barrier coatings, such as for example soft coatings, based on silver layers, but also hard coatings, based on SnOₓ:F, or to apply sun protective layers. In order to achieve a coloring effect it is conceivable to employ colored glass for one pane of the glass composite or for the monopane. It is also conceivable to employ a decorative glass.

While the gaps in the insulating glass composites are filled with noble gases, it is also conceivable to insert a medium, such as for example a cooling medium, between the two panes.

FIG. 5b depicts a similar construction as FIG. 5a, but where instead the lighting devices 740 in the composite glass element 700 are included into a film 702, which is inserted in between the two panes 720 and 760 with other films, such as for example an adhesive film (not shown), which were previously described. Otherwise, the construction is the same as the one depicted in FIG. 5a, and so the reference numbers for the components are the same as in FIG. 5a, except that 200 was added to each of the numbers.

FIG. 5c depicts the construction of an insulating glass element, which is shown with two multilayer glass pane composites 800 and 900. For a construction of this type it is conceivable to add the lighting devices 840 into the composite glass element 800. The lighting devices can be included into a film, as was previously shown in FIG. 5b. The film with the lighting devices on the other hand is placed in between the two panes 820 and 860 by the use of adhesive films. Instead of the monopane, a glass composite element 900 is located at the interior side (INTERIOR) composed out of two panes 904 and 906; but it is also conceivable to employ more than two panes, such as for example three panes. The film 908 which was laminated into this glass composite element can be, for example, a film 908 with liquid crystals, which can be switched from a cloudy and dull state to a clear and transparent state, or it can be in part a film that contains scatter centers to facilitate, for example, projections from the front or the back. FIG. 5c is otherwise labeled such that identical components carry the same reference numbers. The distance between the two composite glass elements, which comprise the insulating glass element, is ensured with a spacer element, for example with a metal spacer element, preferably out of aluminum.

FIG. 5d depicts a particularly simple adaptation of an insulating glass element 950 including a transparent substrate 952, which holds lighting devices 954.1, 954.2 and 954.3, and a cover pane 960. The cover pane 960 and the transparent substrate 952 are both single glass panes, such as for example soda-lime glasses. An electrically conducting coating 958 has again been applied on the transparent substrate 952, which is the basis for the strip conductors or conductor tracks for each of the lighting devices 954.1, 954.2 and 954.3. The transparent or quasi-transparent substrate 952 and the cover pane 960 are forming an insulating glass composite 950. A spacer element 962 is placed between the two pane shape elements 960 and 952, and sealed against the pane shape elements by use of a sealant material, which preferably consists out of butyl rubber. The gap that exists between the two panes 960 and 952 can be filled with a noble gas, but it is also conceivable to fill it with another medium, such as for example a cooling medium.

FIG. 5e shows another adaptation of an insulating glass element 980, which includes a transparent substrate 982 that is part of a glass composite 956. The lighting devices 954.1, 954.2 and 954.3 are in between the transparent substrate 982 and a pane 983 that is connected with that substrate. The composite glass element 956 again is connected through a spacer element 992 to a solar module 988. The solar module is transparent to light and carries the reference number 988. Once again, the interior side of the insulating glass composite is denoted INTERIOR and the exterior side is denoted with EXTERIOR.

The impinging sunlight shines directly onto the solar module, while the light, which is emitted from the LED's can transmit through the solar module to the outside, denoted as EXTERIOR, can be seen on the outside because of the transparency of the solar module.

But a reverse configuration is also conceivable, as shown in FIG. 5f.

In the reverse configuration, the solar module is located on the inside while the composite glass element with the lighting devices is located on the outside. Otherwise the assembly is identical to that depicted in FIG. 5f. Because of the transparency of the composite glass element, enough light falls onto the solar module after transmitting through the composite glass element with the lighting devices on it.

A façade is of course also conceivable that is in part composed out of façade elements that are according to the façade elements proposed by this invention and to another part out of façade elements that are comprised of solar modules. The solar modules are thereby arranged next to the transparent elements in a modular fashion.

Façade with solar modules, such as previously described, have the decided advantage, that they can absorb solar energy and convert it into electric energy. In the presence of energy storage devices it is possible to use this electric energy at a later time, for example to provide power for the lighting devices.

The transparent element according to this proposed invention with a transparent substrate can be employed as a part, preferably as a modular component, of a façade construction of a multimedia façade or a large-area display device with surface of 10 square meters, 20 square meters, 50 square meters, 100 square meters, 1,000 square meters, 3,000 square meters or even more. The individual transparent elements have sizes of, for example 2 m×2 m, 2 m×5 m or 2 m×10 m.

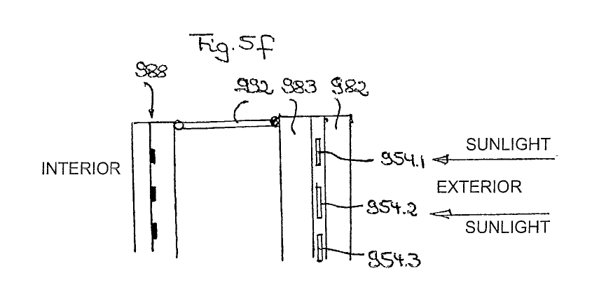

FIG. 6 depicts a media façade according to this proposed invention. The media façade carries the reference number 1000. The media façade includes at least one of the elements shown in the depicted adaptation. This illustrated adaptation actually depicts a larger number of different elements. Depicted here are four preferred transparent elements 1002.1, 1002.2, 1002.3 and 1002.4, which are according to the proposed invention fitted with light-emitting diodes that are mounted to a particular portion of a façade 1010, for example a building with interior space, and attached with the typical fastening devices as they are known to the experts of the trade. The elements according to this proposed invention can be configured as shown in FIG. 3, FIGS. 4a through 4c, or FIGS. 5a through 5f. It is important that the transparent element can hold lighting devices, which are to be applied on transparent substrates. The transparent elements are preferably standard elements with surface areas of, for example 2 m×2 m, preferably 2 m×4 m, or also 2 m×10 m. The four depicted elements would accordingly comprise a display area of 80 square meters, if each of the individual transparent elements were to have display areas of 2 m×10 m.

The individual façade elements 1002.1, 1002.2, 1002.3 and 1002.4 each contain a plurality of light-emitting diodes, preferably RGB light-emitting diodes, that are preferably arranged in a pixel structure, and which can be individually controlled in order to produce moving pictures 1050, such as for example television pictures, on the front of the transparent media façade.

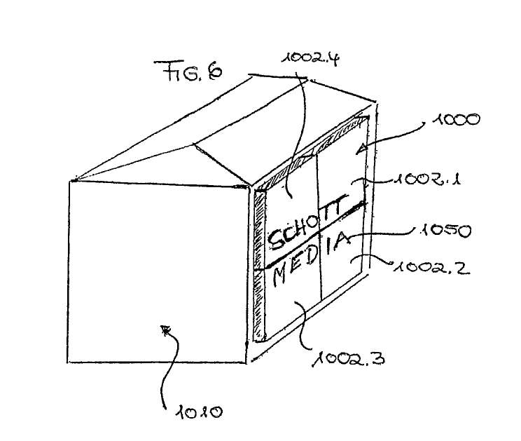

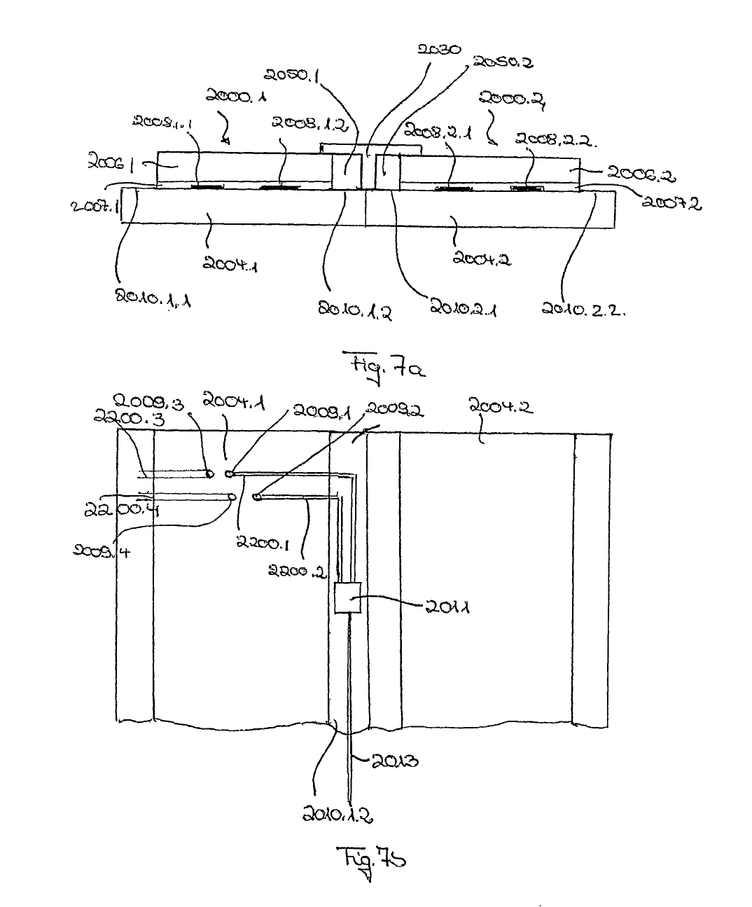

FIGS. 7a and 7b depict the first possibility of an adaptation of individual, transparent modules, which are connected to one another, in order to form a media façade.

FIG. 7a shows a section cut through two such modules that are connected to one another and FIG. 7b shows a top view onto two such modules. The first module is denoted with the reference number 2000.1, and the second module is denoted with the reference number 2000.2. Each of the modules 2000.1 and 2000.1 comprise a transparent substrate 2004.1 for the module 2000.1 and a transparent substrate 2004.2 for the module 2000.2, on which the lighting devices 2008.1.1 and 2008.1.2, as well as 2008.2.1 and 2008.2.2, respectively. The lighting devices are again soldered onto so called electric connection pads, which are in turn each connected to individual strip conductors or conductor tracks that have been selectively structured out of the electrically conducting layers that were applied to the transparent substrates 2004.1 and 2004.2. The transparent element 2000.1 includes furthermore a cover pane or another second pane 2006.1 and 2006.2. The second pane, which is also transparent or quasi-transparent, is connected to the first pane, for example by inserting a casting resin 2007.1 and 2007.2 into the gaps between the panes 2006.1 and 2006.2, respectively, or to connect the mating panes with, for example PVB film, in order to form elements.

The section cut in FIG. 7a demonstrates that the carrier substrate for the lighting devices 2004.1 and 2004.2 is always wider than the cover pane 2006.1 and 2006.2. Because of this there are edge regions 2010.1.1, 2010.1.2, 2010.2.1 and 2010.2.2 on each side of the substrate 2004.1. The electric leads from each of the lighting devices are positioned to extend to this particular edge region of the transparent substrate. The bus bars 2012.1.1, 2012.1.2, 2012.2.1 and 2012.2.2, which extend along the edge regions of the carrier substrates, supply the light-emitting diodes on the substrate with electric power.

If two modules are connected with one another, as depicted in FIG. 7a, this connection is achieved by inserting a T-block 2030, which is lying on top of the cover panes and reach in between the two modules 2000.1 and 2000.2. This results in small gaps 2050.1 and 2050.2 along the edge region of the optical elements 2004.1 and 2004.2. It is in these edge regions where the electronic control circuitry and the bus bars can be placed. The electronic control circuitry and the bus bars can then be connected via cables with the external components, such as for example electric power supplies. It is also possible to integrate into these gaps the control electronics for an entire transparent component, and then to only lead the electric power for the control electronics through these gaps.

FIG. 7b depicts a top view of a portion of a transparent optical element 2004.1 and 2004.2. In general this represents the transparent substrates with the associated edge section. FIG. 7b depicts very clearly how the individual lighting devices, in particular light-emitting diodes 2009.1, 2009.2, 2009.3 and 2009.4 that are located on the transparent substrate are supplied with electric power through a number of parallel lines 2200.1, 2200.2, 2200.3 and 2200.4, which all extend to the edge 2010.1.2 and from there to an electronic control system and/or power supply. The resulting gaps between the individual, adjacent modules are then again connected with the help of a T-block, as depicted in FIG. 7a. Only one single cable 2013 leads from this control system 2011 to the outside.

FIG. 7c depicts an alternative adaptation of a connection between two modules.

The first module is denoted with the reference number 3000.1, and the second module is denoted with the reference number 3000.2. Each module includes a transparent substrate, i.e. 3004.1 for module 3000.1 and 3004.2 for module 3000.2, respectively, and each module includes lighting devices, i.e. 3008.1.1 and 3008.1.2 for module 3004.1 and 3008.2.1 and 3008.2.2 for module 3000.2. The lighting devices are again preferably soldered onto so called connector pads, which in turn are connected to the strip conductors or conductor tracks that have been selectively structured out of the electrically conducting and transparent layers 3004.1 and 3004.2 that were applied to the transparent substrates.

The transparent element 3000.1 includes furthermore a cover pane or another second pane 3006.1 and 3006.2. The second pane, which is also transparent or quasi-transparent, is connected to the first transparent element, which can be achieved by either inserting a casting resin into the gap between the two panes 3006.1 and 3006.2 or by inserting adhesive films, such as for example RVB films, thus forming one element. The section cut depicted in FIG. 7c demonstrates that the carrier substrate for the lighting devices 3004.1 and 3004.2 is always wider on one side than the cover pane 3006.1 and 3006.2. Because of this there is an edge region 3010.1 on one each end of the substrate 3004.1. On the opposing side, the carrier substrate 3004.1 is shorter than the cover pane 3006.1. This is where the cover pane 3006.1 extends past the carrier substrate 3004.1 into the edge region 3010.1. It is preferred that the extent by which the substrate 3004.1 extends into the edge region 3010.1, as well as the cover pane 3006.1 extending into the edge region 3010.2 such that they are equal. FIG. 7c illustrates how this allows that on the side where the carrier substrate of the module 3000.1 stands out, it will be met by the outstanding portion of the cover pane of the adjacent module 3000.2, i.e. it will be covered by it. This way makes it possible to provide a system where one module can connect seamlessly to the next module. A T-block is in this adaptation not necessary, as opposed to the adaptations depicted in FIG. 7a and FIG. 7b.

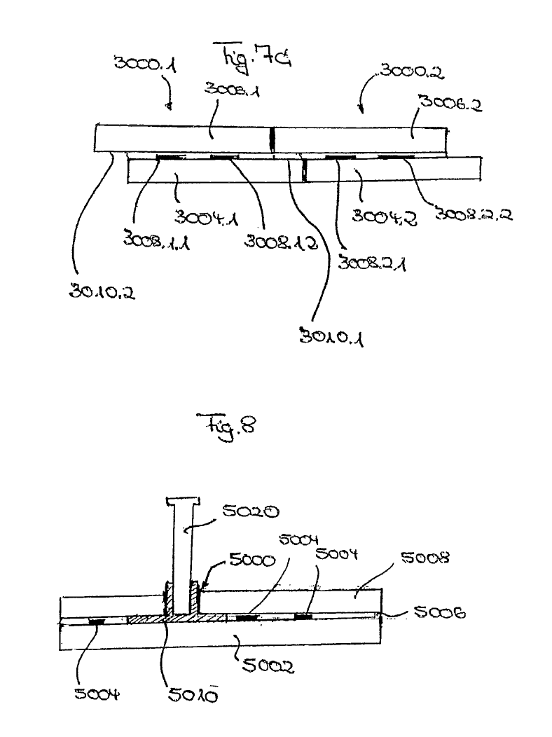

FIG. 8 depicts the connection of a transparent optical element, consisting of two panes, as shown in FIGS. 7a and 7b, with a façade.

It is hereby preferred to introduce drilled holes into the transparent substrate as well as into the cover pane. These drilled holes are denoted with the reference number 5000. These drilled holes with the reference number 5000 can be used to insert fasteners, such as for example screws. With the help of these screws, the façade elements can be mounted on the building. Such fastener elements can also be hollow, to allow cables to be led to the outside of the modules.

It is especially preferred if the façade element is in the form of composite elements, as it is depicted, consisting out of a transparent substrate 5002 with lighting devices 5004 attached to it, as well as a cover pane. It is preferred that the attachment to the building is such that an insert 5010, such as for example a sleeve with an internal thread is glued onto the transparent substrate 5002 using a glass-metal glue. Next, an intermediate layer 5006 is inserted between the transparent substrate 5002 and the cover pane 5008, such as for example a cast resin or an adhesive film. With the help of the cast resin or the adhesive film, the cover pane 5008 is fixed onto the transparent substrate 5002, resulting in composite element.

The insert 5010 is connected with a functional element, for example with a threaded bolt to fasten. The insert 5010 is introduced before the transparent element 5002 is assembled with the cover pane 5008 to form the composite element. To achieve this, a metallic insert 5010 is first glued onto the substrate by use of hardenable glass-metal glue. After the metallic insert 5010 is glued by use of hardenable glass-metal glue onto the transparent pane the intermediate layer 5006 is applied onto the transparent pane, before finally the cover pane 5008 is glued on with the help of the intermediate layer, thus forming the composite element.

With this invention it is possible to offer transparent media façades, which excel on one side with their transparency in and out of the building, while on the other side offer a very simple structure that requires very little maintenance and upkeep compared to the media façades of the current state of technology.

It is furthermore possible to minimize losses, if the strip conductors or conductor tracks that serve as electrical supply lines to the individual light-emitting diodes are highly conductive strip conductors or conductor tracks. Such strip conductors or conductor tracks are for example part of a system such as:

transparent substrate/TiO₂/SnO₂:F.

The conductivity of such systems or strip conductors or conductor tracks is in the range between 3·10⁻⁴ Ohm·cm to 6·10⁻⁴ Ohm·cm, in particular 5·10⁻⁴ Ohm·cm to 5.5·10⁻⁴ Ohm·cm [Ω·cm]. For a highly conductive layer system of the structure:

transparent substrate/TiO₂/SnO₂:F

the preferred coating thickness for the TiO₂ layer is in the range between 5 nm up to 50 nm, preferably in the range between 10 nm up to 30 nm, and the preferred coating thickness for the SnO₂ layer is in the range between 200 nm up to 2,000 nm, in particular in the range between 500 nm up to 600 nm.

Highly conductive strip conductors or conductor tracks as they have been described heretofore can be employed in all of the elements that were described in this proposed invention, in particular in the in display elements, and they are not limited to just a few of the applications that were mentioned in this proposed invention.

The highly conductive strip conductors or conductor tracks or coated layers have the decided advantage of less conductive strip conductors or conductor tracks or coated layers that they do not tend to heat up, which prevent colorization or the detachment from the transparent substrate. It is furthermore possible to dereflect a glass with highly conductive strip conductors or conductor tracks, for example by applying an anti-reflection layer.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A large-area display device, comprising:
at least one transparent element which includes at least one transparent substrate and at least one lighting device which is mounted onto said at least one transparent substrate, the large-area display device being a transparent large-area display device.

2. The large-area display device according to claim 1, wherein said transparent large-area display device is a media façade.

3. The large-area display device according to claim 2, wherein said at least one transparent element includes a plurality of said lighting device, said plurality of lighting devices being a plurality of light-emitting diodes which are mounted onto said at least one transparent substrate.

4. The large-area display device according to claim 3, wherein said at least one transparent element includes one of a plurality of strip conductors and a plurality of conductor tracks on said at least one transparent substrate, said one of said plurality of strip conductors and said plurality of conductor tracks being configured for facilitating a supply of electric power.

5. The large-area display device according to claim 4, wherein said at least one transparent element includes an electrically conducting and power transmitting layer which forms said one of said plurality of strip conductors and said plurality of conductor tracks.

6. The large-area display device according to claim 5, wherein said one of said plurality of strip conductors and said plurality of conductor tracks are transparent.

7. The large-area display device according to claim 6, wherein said at least one transparent substrate is made out of glass.

8. The large-area display device according to claim 6, wherein said at least one transparent substrate is made out of soda-lime glass.

9. The large-area display device according to claim 6, wherein said at least one transparent substrate is configured at least one of for supplying electric power through a plurality of connections and for exerting control over said plurality of lighting devices through said one of said plurality of strip conductors and said plurality of conductor tracks, respectively.

10. The large-area display device according to claim 6, wherein said plurality of light-emitting diodes are Red Green Blue (RGB) light-emitting diodes which are configured for generating any kind of picture through electronic control.

11. The large-area display device according to claim 6, wherein said plurality of lighting devices are integrated into said at least one transparent substrate.

12. The large-area display device according to claim 6, wherein said at least one transparent element includes a plurality of said transparent substrate, said plurality of transparent substrates being shaped as a plurality of panes which are one of flat and curved.

13. The large-area display device according to claim 6, wherein said at least one transparent element includes a casting resin layer.

14. The large-area display device according to claim 6, wherein said at least one transparent element includes a film.

15. The large-area display device according to claim 14, wherein said film includes at least one said lighting device.

16. The large-area display device according to claim 14, wherein said film includes a plurality of liquid crystals.

17. The large-area display device according to claim 14, wherein said film includes a plurality of scatter centers.

18. The large-area display device according to claim 6, wherein said at least one transparent element includes at least one pane, said pane being selected from one of the following panes: anti-reflection coated monopane; multilayer glass pane composite; decorative glass; monopane of a color effect glass; heat protective glass pane; transparent or quasi-transparent ceramic glass; sun protective glass pane; or monopane with a structured glass surface.

19. The large-area display device according to claim 6, further including one of an insulating glass laminate and a Double-Glazing Unit (DGU), said at least one transparent element being a part of one of said insulating glass laminate and said Double-Glazing Unit (DGU).

20. The large-area display device according to claim 6, wherein said one of said plurality of strip conductors and said plurality of conductor tracks, respectively, forming a plurality of electric circuits which are configured for supplying electric power to and for exerting control over said plurality of lighting devices such that each individual one of said plurality of lighting devices is controlled separately.

21. The large-area display device according to claim 20, wherein said plurality of lighting devices on said at least one transparent substrate are arranged as a matrix of points.

22. The large-area display device according to claim 20, further including a computer, a power supply of said plurality of lighting devices being connected to said computer, each individual one of said plurality of electric circuits being freely programmably controlled.

23. The large-area display device according to claim 6, wherein said one of said plurality of strip conductors and said plurality of conductor tracks are highly conductive with a resistance R≦15 Ohm/square (Ω/cm²).

24. The large-area display device according to claim 6, wherein said one of said plurality of strip conductors and said plurality of conductor tracks are highly conductive with a resistance R≦10 Ohm/square (Ω/cm²).

25. The large-area display device according to claim 6, wherein said one of said plurality of strip conductors and said plurality of conductor tracks are highly conductive with a resistance R≦9 Ohm/square (Ω/cm²).

26. The large-area display device according to claim 6, wherein said one of said plurality of strip conductors and said plurality of conductor tracks are highly conductive with a resistance R≦7 Ohm/square (Ω/cm²), especially preferred R≦5 Ohm/square (Ω/cm²).

27. The large-area display device according to claim 6, wherein said one of said plurality of strip conductors and said plurality of conductor tracks are highly conductive with a resistance R≦5 Ohm/square (Ω/cm²).

28. The large-area display device according to claim 6, wherein said electrically conducting and power transmitting layer is transparent, a thickness of said one of said plurality of strip conductors and said plurality of conductor tracks being ≧150 nm.

29. The large-area display device according to claim 6, wherein said electrically conducting and power transmitting layer is transparent, a thickness of said one of said plurality of strip conductors and said plurality of conductor tracks being ≧180 nm.

30. The large-area display device according to claim 6, wherein said electrically conducting and power transmitting layer is transparent, a thickness of said one of said plurality of strip conductors and said plurality of conductor tracks being ≧280 nm.

31. The large-area display device according to claim 6, wherein said electrically conducting and power transmitting layer is transparent, a thickness of said one of said plurality of strip conductors and said plurality of conductor tracks being ≧420 nm.

32. The large-area display device according to claim 6, wherein said electrically conducting and power transmitting layer is transparent, a thickness of said one of said plurality of strip conductors and said plurality of conductor tracks being ≧500 nm, particularly preferred ≧550 nm.

33. The large-area display device according to claim 6, wherein said electrically conducting and power transmitting layer is transparent, a thickness of said one of said plurality of strip conductors and said plurality of conductor tracks being ≧550 nm.

34. The large-area display device according to claim 6, wherein said electrically conducting and power transmitting layer is transparent, said one of said plurality of strip conductors and said plurality of conductor tracks including at least one of the following metal oxides: InOₓ:Sn; SnOₓ:F; SnOₓ:Sb; ZnOₓ:Ga; ZnOₓ:B; ZnOₓ:F; ZnOₓ:Al; or Ag/TiOₓ.

35. The large-area display device according to claim 6, wherein said one of said plurality of strip conductors and said plurality of conductor tracks on said at least one transparent substrate are thin metallic and are made out of silver.

36. The large-area display device according to claim 2, wherein the transparent large-area display device includes a display surface area of more than 10 square meters.

37. The large-area display device according to claim 2, wherein the transparent large-area display device is transparent and includes a display surface area of more than 50 square meters.

38. The large-area display device according to claim 2, wherein the transparent large-area display device is transparent and includes a display surface area of more than 100 square meters.

39. The large-area display device according to claim 2, wherein the transparent large-area display device is transparent and includes a display surface area of more than 1,000 square meters.

40. The large-area display device according to claim 2, wherein the transparent large-area display device is transparent and includes a display surface area of more than 3,000 square meters.

41. The large-area display device according to claim 2, wherein the transparent large-area display device is transparent and includes a display surface area of more than 5,000 square meters.

42. The large-area display device according to claim 2, wherein the transparent large-area display device includes a display area and a plurality of said transparent element, said plurality of transparent elements being a plurality of modular transparent elements, said display area including said plurality of modular transparent elements.

43. The large-area display device according to claim 2, wherein said at least one transparent element includes a plurality of said lighting device, the transparent large-area display device including more than 1,000 individual said lighting devices.

44. The large-area display device according to claim 2, wherein said at least one transparent element includes a plurality of said lighting device, the transparent large-area display device including more than 5,000 individual said lighting devices.

45. The large-area display device according to claim 2, wherein said at least one transparent element includes a plurality of said lighting device, the transparent large-area display device including more than 10,000 individual said lighting devices.

46. The large-area display device according to claim 2, wherein said at least one transparent element includes a plurality of said lighting device, the transparent large-area display device including more than 100,000 individual said lighting devices.

47. The large-area display device according to claim 2, wherein said at least one transparent element includes a plurality of said lighting device, the transparent large-area display device including more than 150,000 individual said lighting devices.

48. The large-area display device according to claim 2, wherein said at least one transparent element includes a plurality of said lighting device, the transparent large-area display device including more than 1,000,000 individual said lighting devices.

49. The large-area display device according to claim 2, wherein the transparent large-area display device includes at least two of said transparent element, said at least two transparent elements being at least two modules respectively, said at least two modules each including at least one said transparent substrate and one cover pane, each said transparent substrate including an edge and an edge region and being at least along one said edge longer than an associated said cover pane such that said edge region of a corresponding said transparent substrate is formed.

50. The large-area display device according to claim 49, wherein each said transparent element includes a plurality of said lighting device, the large-area display device further including a common power supply and a plurality of leads to said lighting devices, said plurality of leads including a plurality of ends, said plurality of ends of said plurality of leads to said plurality of lighting devices that are arranged on said transparent substrates being located along a respective said edge region where said plurality of ends connect with said common power supply.

51. The large-area display device according to claim 49, wherein said at least two modules are connected with one another using at least one connecting device formed as a T-block.

52. The large-area display device according to claim 2, wherein the transparent large-area display device includes an assembly configured for mounting said at least one transparent element on a façade.

53. The large-area display device according to claim 52, wherein said at least one transparent element includes a cover pane coupled with said at least one transparent substrate, at least one of said at least one transparent element and said cover pane defining a plurality of drilled holes, said assembly being a plurality of connector devices sticking through said plurality of drilled holes in at least one of said at least one transparent substrate and said cover pane respectively.
